(19) United States
(12) Patent Application Publication
(10) Pub. No.: US 2025/0353105 A1
(43) Pub. Date: Nov. 20, 2025

(54) BEAM SHAPING FOR CUTTING

(71) Applicant: II-VI Delaware, Inc., Wilmington, DE (US)

(72) Inventors: Jeroen Jonkers, Berlin (DE); Patrick Kuehl, Berlin (DE); Georg Schmidt, Heidesee (DE); Paul Sonntag, Strahlsund (DE)

(21) Appl. No.: 18/664,999

(22) Filed: May 15, 2024

(51) Int. Cl. B23K 26/06; B23K 26/073; B23K 26/38

(52) U.S. Cl. CPC B23K 26/0617; B23K 26/0736; B23K 26/38

(57) ABSTRACT

Systems for processing a workpiece are disclosed herein. The systems may include: a laser cutting head configured to produce a laser beam spot pattern comprising a plurality of laser beam spots, where at least two laser beam spots of the plurality of laser beam spots being disposed within the laser beam spot pattern symmetrically from a centerline defined by a cutting path for processing the workpiece. Methods of processing a workpiece are disclosed herein. The methods may include emitting, by a laser cutting head, a laser beam spot pattern comprising at least two laser beam spots, each disposed within the laser beam spot pattern and symmetrically positioned away from a centerline of a processing path of the workpiece; and removing portions of the workpiece using the laser beam spot pattern along the cutting path of the workpiece.

### FIELD

The embodiments disclosed herein are in the field of laser devices, systems, and method used to process materials. More particularly, the embodiments disclosed herein relate to laser devices used for material processing using shaped beams, systems, and methods.

### BACKGROUND

Unless otherwise indicated herein, the materials described herein are not prior art to the claims in the present application and are not admitted to be prior art by inclusion in this section.

Existing laser devices use produced laser beams to process materials in an inefficient manner. In general, current laser devices used in laser cutting result in creating rough sidewalls adjacent to the kerf with poor perpendicularity to the top/bottom surfaces of the workpiece being cut. The rough sidewalls are considered to be the result of inconsistent energy densities generated by the laser beams used to cut through a thickness of the workpiece along a travelling direction of the laser beam. In most instances, the laser beam pattern produced by the laser device is generally a single circular laser spot focused upon the workpiece. As a result, the resulting density of the accumulated energy from the laser beam is concentrated at a region spaced apart from the resulting sidewalls, i.e., an elliptical cutting front may form, whose maximum power is usually in the center and therefore not at the edge and sidewalls have rough surfaces through a thickness of the workpiece and the sidewalls are not substantially perpendicular to the top/bottom surfaces of the workpiece. Moreover, in some instances, the temperature of resulting molten material varies through the thickness of the workpiece as the laser beam is moved along a cutting path creating further irregularities with respect surfaces of the sidewalls, as well as creating solidified dross on the bottom surface of the workpiece. Accordingly, improvements over prior art laser devices for laser beam production are desired.

Additionally, it is believed that the amount of time that the laser beam patterns interact with the workpiece is insufficient to efficiently remove material of the workpiece to form relatively smooth sidewall surfaces along the kerf that have satisfactory perpendicularity to the top/bottom surfaces of the workpiece being cut. Moreover, removal of substantial amounts of workpiece material may result, such that a width of the kerf is larger, and removal of the molten material along the opposing sidewalls is problematic. Accordingly, it is desired to improve prior art laser devices for laser beam processing in order to improve laser cutting efficiency.

The subject matter claimed herein is not limited to implementations that solve any disadvantages or that operate only in environments such as those described above. Rather, this background is only provided to illustrate one example technology area where some implementations described herein may be practiced.

These and other advantages of the present invention will become more fully apparent from the detailed description of the invention herein below.

### SUMMARY

This summary is provided to introduce a selection of concepts in a simplified form that are further described below in the detailed description. This summary is not intended to identify key features or essential characteristics of the claimed subject matter, nor is it intended to be used as an aid in determining the scope of the claimed subject matter.

Disclosed herein are systems for processing a workpiece. In one aspect of the disclosure, a laser cutting head configured to produce a laser beam spot pattern may include a plurality of laser beam spots, where at least two laser beam spots of the plurality of laser beam spots are disposed within the laser beam spot pattern symmetrically from a centerline defined by a cutting path for processing the workpiece. In another aspect of the disclosure, at least two laser beam spots have one of a circular shape and an elongated shape, and where at least two laser beam spots have a center region spaced apart from the centerline of the cutting path by a distance. In another aspect of the disclosure, a plurality of laser beam spots includes an additional laser spot disposed within the laser beam spot pattern and disposed symmetrically along the centerline of the cutting path. In yet another aspect of the disclosure, at least one of the laser beam spots has an energy intensity distribution profile that may include at least one of a gaussian profile, a top-hat profile, and a ring profile. In one aspect of the disclosure, each of the at least two laser beam spots include an oval-shape. In one aspect of the disclosure, the least two laser beam spots include at least three laser beam spots, in which the at least three laser beam spots are symmetrically disposed apart from the centerline of the cutting path.

Disclosed herein are laser processing systems. The laser processing systems, in one aspect of the disclosure includes a laser cutting head configured to process a workpiece, and a process controller configured to control the laser cutting head to produce a laser beam spot pattern, which may include at least two laser beam spots, each disposed within the laser beam spot pattern and symmetrically positioned away from a centerline of a cutting path of the workpiece. In another aspect of the disclosure, implementations may include the at least two laser beam spots having one of a circular shape, an oval shape, and an elongated shape. In one aspect of the disclosure, the at least two laser beam spots have a center region spaced apart from a centerline of the cutting path by a distance. In one aspect of the disclosure, the laser beam spot pattern includes an additional laser spot disposed within the laser beam spot pattern and disposed symmetrically along a centerline of the cutting path. In another aspect of the disclosure, the laser beam spot pattern has an energy intensity distribution profile including one of a gaussian profile, a flat-top profile, and ring profile. In another aspect of the disclosure, each of the at least two laser beam spots includes an oval-shape. In another aspect of the disclosure, the at least two laser beam spots include a first pair of laser beam spots and a second pair of laser beam spots, each symmetrically disposed apart from a centerline of the cutting path. In yet another aspect of the disclosure, a cutting path is non-linear and the process controller is configured to rotate the laser beam spot pattern to maintain an alignment with the cutting path.

Disclosed herein are methods of processing a workpiece. The methods include emitting, by a laser cutting head, a laser beam spot pattern that may include at least two laser beam spots, each disposed within the laser beam spot pattern and symmetrically positioned away from a centerline of a processing path of the workpiece; and removing portions of the workpiece using the laser beam spot pattern along the cutting path of the workpiece. In another aspect of the disclosure, the methods may include emitting a laser beam spot pattern where the at least two laser beam spots have one of a circular shape and an oval shape. In one aspect of the disclosure, the at least two laser beam spots have a center region spaced apart from a centerline of the cutting path by a distance. In one aspect of the disclosure, the laser beam spot pattern includes an additional laser spot disposed within the laser beam spot pattern and disposed symmetrically along a centerline of the cutting path. In one aspect of the disclosure, the laser beam spot pattern has an energy intensity distribution profile including one of a gaussian profile, a flat-top profile, and ring profile. In yet another aspect of the disclosure, each of the at least two laser beam spots include an oval-shape. In one aspect of the disclosure, at least two laser beam spots include a first pair of laser beam spots and a second pair of laser beam spots, each symmetrically disposed apart from a centerline of the cutting path. In another aspect of the disclosure, the processing path may be non-linear and the method further may include rotating the laser beam spot pattern to maintain an alignment with the processing path.

Disclosed methods, process controllers, and control systems can be configured to perform particular operations or actions by virtue of having software, firmware, hardware, or a combination of them installed on a system that in operation causes or cause the system to perform the actions or methods. One or more computer programs can be configured to perform particular operations or actions by virtue of including instructions that, when executed by data processing apparatus, cause the apparatus to perform the actions.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a schematic diagram illustrating a general configuration of a system for processing a workpiece;

FIG. 2 is a cross-sectional view of general processing of a workpiece; and

FIGS. 3A and 3B are a schematic diagram illustrating a general configuration for processing a workpiece and a diagram of an accumulated energy intensity distribution profile;

FIGS. 4A and 4B are a schematic diagram illustrating another general configuration for processing a workpiece and a diagram of an accumulated energy intensity distribution profile;

FIGS. 5A and 5B are a schematic diagram illustrating an exemplary configuration for processing a workpiece and a diagram of an accumulated energy intensity distribution profile;

FIGS. 6A and 6B are a schematic diagram illustrating another exemplary configuration for processing a workpiece and a diagram of an accumulated energy intensity distribution profile;

FIGS. 7A and 7B are a schematic diagram illustrating another exemplary configuration for processing a workpiece and a diagram of an accumulated energy intensity distribution profile;

FIGS. 8A and 8B are a schematic diagram illustrating another exemplary configuration for processing a workpiece and a diagram of an accumulated energy intensity distribution profile;

FIGS. 9A and 9B are a schematic diagram illustrating another exemplary configuration for processing a workpiece and a diagram of an accumulated energy intensity distribution profile;

FIGS. 10A and 10B are schematic diagrams illustrating another exemplary configuration for processing a workpiece;

FIGS. 11A-C are schematic diagrams illustrating another exemplary configuration for processing a workpiece;

FIGS. 12A and 12B are schematic diagrams illustrating another exemplary configuration for processing a workpiece;

FIGS. 13A-C are schematic diagrams illustrating another exemplary configuration for processing a workpiece;

FIGS. 14A and 14B are schematic diagrams illustrating another exemplary configuration for processing a workpiece;

FIG. 15 is a cross section of FIG. 7; and

FIG. 16 is a schematic diagram of a cutting path and beam spot pattern in accordance with disclosed embodiments.

### DETAILED DESCRIPTION

It is to be understood that the figures and descriptions of the present invention may have been simplified to illustrate elements that are relevant for a clear understanding of the present embodiments, while eliminating, for purposes of clarity, other elements found in a laser device or system for operating a laser device. Those of ordinary skill in the art will recognize that other elements may be desirable and/or required in order to implement the present embodiments. However, because such elements are well known in the art, and because they do not facilitate a better understanding of the present embodiments, a discussion of such elements is not provided herein. It is also to be understood that the drawings included herewith only provide diagrammatic representations of the presently preferred structures of the present invention and that structures falling within the scope of the present embodiments may include structures different than those shown in the drawings. Reference will now be made to the drawings wherein like structures are provided with like reference designations. As noted previously, existing laser devices use produced laser beams to process materials. In general, industrial laser cutting of metal plates typically use a multi-mode laser, although single mode lasers may also be used, with a focus diameter of typically less than a millimeter, having a cutting head to melt the material(s) of the metal plates through the thickness of the metal plates along a cutting path of the cutting head. In such configuration, the laser beam at its focal point has a disk-like shape having either an almost homogeneous intensity distribution profile or a Gaussian-like distribution profile. For example, in a Gaussian-like distribution, the intensity distribution profiles along the cutting path provide either a maximum energy concentration at a center of a laser beam spot or an energy concentration that is dramatically reduced as edges of the laser beam spot. So, maximum energy concentrations of the intensity distribution profiles do not consistently match locations of the material(s) that needs to be rendered molten, most notably along sidewalls along the cutting path of the metal plate and at varying depths of the material(s). Additionally, at sidewalls of the material(s) along the cutting path, more heat flux may be required to melt the outer portions of the kerf because heat is lost due to heat conduction into the metal plate outside of the area of laser exposure. As a result, different regions of the process area at different depths of the material may become molten before others, which may increase the uneven production of fluence or dross, e.g., molten portions of the material(s). Accordingly, sidewalls of the cut surfaces of the metal plates are rough through the thickness of the metal plates, and in some instances the dross may adhere to the bottom surface of the metal plates, whereby increased pressure (and flow) of the processing gas, additional heating, or additional post-processing work is required. Accordingly, additional production costs are required to produce processed metal plate that are acceptable for further processing and fabrication.

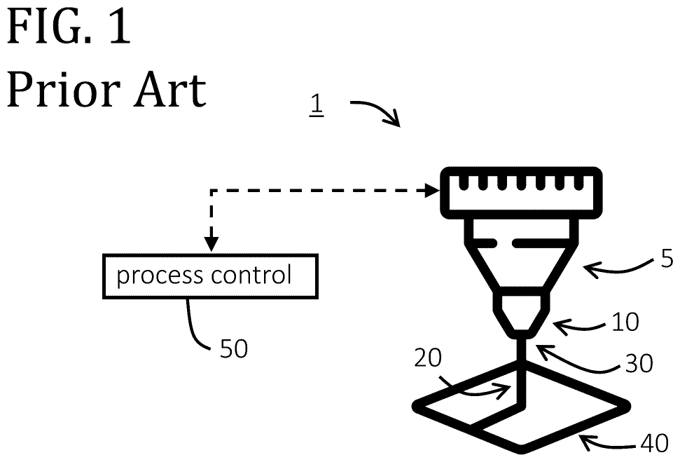

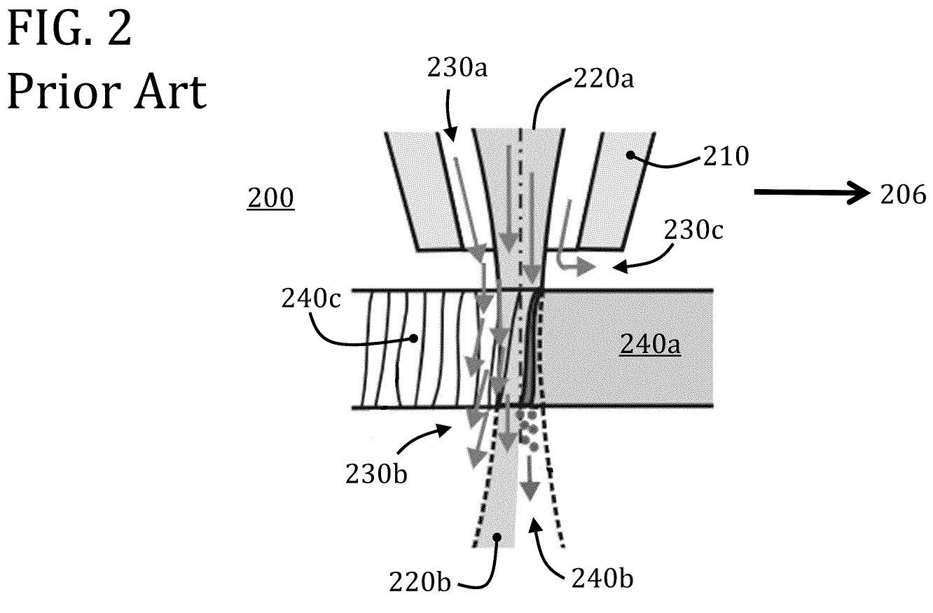

FIG. 1 shows a general configuration of a system for processing a workpiece using a laser beam to cut a metal plate, and FIG. 2 is a cross-sectional view of the laser beam cutting the metal plate. In FIG. 1, a laser system 1 includes a cutting head 5 and a cutting nozzle 10, in which laser beam 20, which propagates through the cutting nozzle 10 with a gas flow 30 concentric with the laser beam 20, is provided to a surface of a workpiece 40 for processing. The laser beam may be sourced from outside the cutting head from a laser drive unit (not shown), e.g., a solid state, diode, or gas laser, and directed through the cutting head through one or more optics or waveguides, for example in free space optics or fiber optic cables. Although not specifically shown, the laser drive unit or cutting head 5 may also include various optical, drive, regulation, and control sub-systems, or other external components, for manipulating the laser beam 20 and/or position the cutting head 5 with respect to the workpiece 40, e.g., cutting machine gantry. The cutting head 5, and any associated drive unit is controlled by a process controller 50 configured to transmit instructions to the cutting head for processing the workpiece 40 and receive communication from the cutting head 5 and any other higher-level guiding machines (not shown) in which the cutting head and controller are integrated.

In FIG. 2, is a close-up section of the cutting/melting zone of a general laser production system 200 that includes a cutting nozzle 210, through which laser beam 220a propagates along with concentric gas flow 230a. As the cutting nozzle 210 follows a cutting path 206 (or cutting direction), the laser beam 220a is projected onto a workpiece 240a, e.g., metal plate. As shown, the narrowest part of the laser beam 220a is within the thickness of the workpiece 240a, but this is not required to be so. As the concentric gas glow flow 230a exits the nozzle 210, and a gas flow portion 230c of the gas flow 230a flows along a direction of the cutting path 206 (as well outwardly from the nozzle 210 over the workpiece 240a in other directions), after being deflected by the workpiece 240a, and a gas flow portion 230b of the gas flow 230a flows downward along a direction substantially perpendicular to the direction of the cutting path 206 and through the kerf cut by the laser beam 220a. Various process gases can be used. For example, compressed air, or an inert gas such as nitrogen may used as the gas for the gas flow, or alternatively, pure oxygen, or other reactive gases, or gas mixtures may be used to take advantage of the exothermic reaction with the molten material(s).

As the laser beam 220a melts material(s) of the workpiece 240a, molten material(s) 240b of the workpiece 240a are produced and expelled downward by the gas flow 230a or by resulting reaction products, e.g., in the case of using active gases. However, as the molten material(s) of the workpiece 240a is expelled along the direction of the gas flow 230a, portions 220b of the projected laser beam 220a also pass through the workpiece 240a. Accordingly, the portions 220b of the projected laser beam 220a that pass through the workpiece 240a are unused in the processing of the workpiece 240a, and energies associated with the portions 220b of the projected laser beam 220a are wasted. Additionally, as the cutting nozzle 210 progresses along the direction of the cutting path 206, sidewall portions 240c of the workpiece 240a, which define a kerf associated with the processing (melting) of the workpiece 240a, are not well defined with respect to constant sidewall separation widths and perpendicularity of the sidewalls. Moreover, the sidewall portions 240c include a textured surface as a result of the projected laser beam 220a passing through a thickness of the workpiece 240a as the cutting nozzle 210 progresses along the cutting path 206; the formation of surface structures and roughness is complex and is often an interaction of a large number of process parameters. In some instances, additional processing time and materials may be required to remove the textured sidewall portions 240c or accumulated dross from the underside of the workpiece (not shown in FIG. 2).

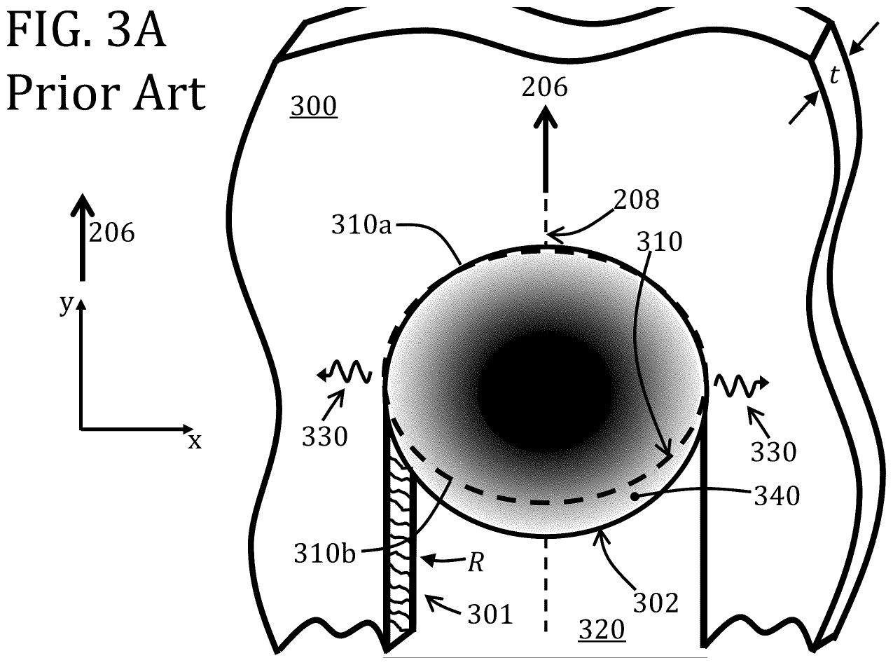

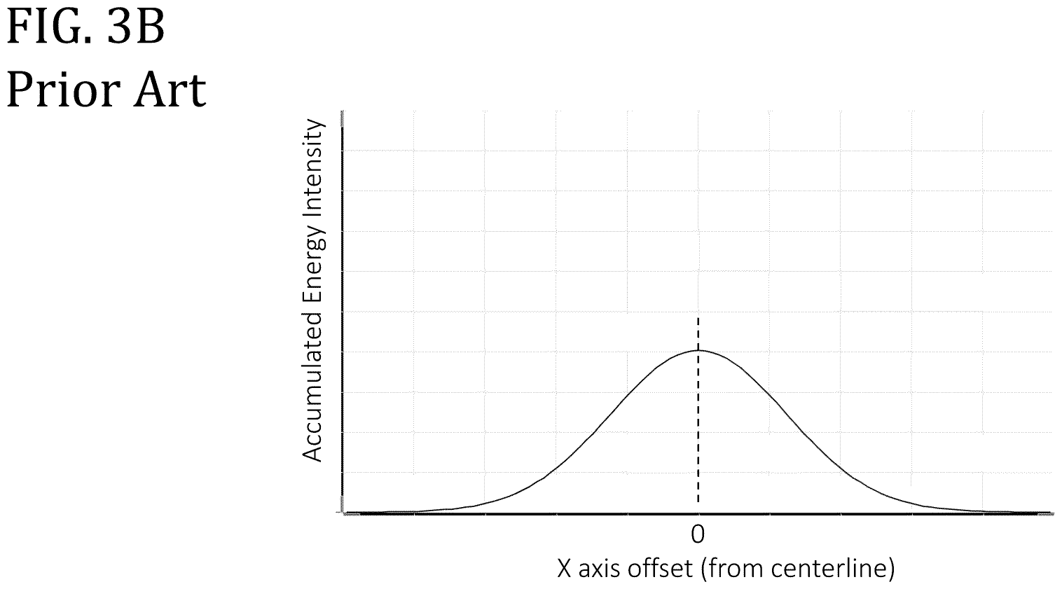

FIG. 3A shows a general configuration for processing a workpiece using a laser beam to cut a metal plate. In FIG. 3A, a laser beam spot 302 is used to cut workpiece 300, e.g., metal plate. The laser beam spot 302, i.e., the profile at the beam focal point, includes a beam spot profile having an energy intensity profile with a Gaussian distribution with the circle identified as 302 indicating the approximation of the outer extent of the beam spot profile. Accordingly, a maximum energy intensity is substantially located at a center of the laser beam spot 302, which decreases along a radial direction toward an edge of the laser beam spot 302.

As the laser beam spot 302 is moved along cutting path 206, energy is absorbed by the workpiece 300 and the workpiece 300 is heated. Accordingly, portions of the workpiece 300 are melted and ultimately removed. At any given time the molten region is generally shown as molten region 310 (dashed line) having a leading edge 310a and a trailing edge 310b. As the molten region 310 is removed, e.g., by gas flow, at the trailing edge 310b, a kerf 320 in the workpiece 300 is formed. Additionally, as the laser beam spot 302 moves along cutting path 206, energy of the laser beam spot 302, in the form of heat 330, is lost to the remainder of the workpiece 300, which may contribute to formation of ridges R sidewall portions 301. Further, because regions closer to the center of the kerf will become molten and be expelled prior to the other regions, the trailing edge 310b of the molten region 310 may not extend to the edge of the laser beam spot 302 such that energy 340 of unused portions of the laser beam spot 302 may extend over the trailing edge 310b of the molten region 310, much like portions 220b of the projected laser beam 220a in FIG. 2. As such, energy 340 is lost without providing any melting reaction with the workpiece 300 in order to create kerf 320 in the workpiece 300. Moreover, sidewall portions 301 of the workpiece 300 are formed having a relatively increased number or intensity (as compared to embodiments described herein) ridges R extending through a thickness t of the workpiece 300.

FIG. 3B illustrates an accumulated energy intensity distribution profile of the laser beam spot 302 (in FIG. 3A). The accumulated energy intensity profile represents the amount of energy a given beam spot profile can impart onto a material taken from a single frame of reference perpendicular to the cutting direction, e.g., for a given position on the y axis (FIG. 3A) along the cutting direction 206 the accumulated energy by each position along the x axis (distance perpendicular to cutting direction 206 from the center line 208 or “CL”) or similar as the laser beam passes over that frame of reference. The accumulated energy intensity profile is another way of characterizing a particular laser beam spot 302 in motion over a workpiece and represents how much accumulated energy is deposited to the material per unit of length perpendicular to the cutting direction at a position perpendicular to the cutting direction. The vertical axis (accumulated energy intensity) has the units J/m or power (watts) per length (meter). While intensity is typically measured in power per area, when making a line integral along the cutting direction 206 the accumulated energy intensity is measured in power/length. Given a certain cutting speed, the accumulated energy intensity profile can be converted to an energy deposited per unit of length perpendicular to the cutting direction. In FIG. 3A, laser beam spot 302 has a Gaussian intensity distribution profile so its corresponding energy intensity distribution profile (shown in FIG. 3B) shows a maximum accumulated energy intensity substantially located at a center line 208 of the laser beam spot 302 and dramatically falls-off as the distance from the center line 208 increases. As a result, the center of the laser beam spot 302 performs a majority of melting of material(s) of the workpiece 300 along the cutting path and edge portions of the laser beam spot 302 perform a minority of material(s) melting.

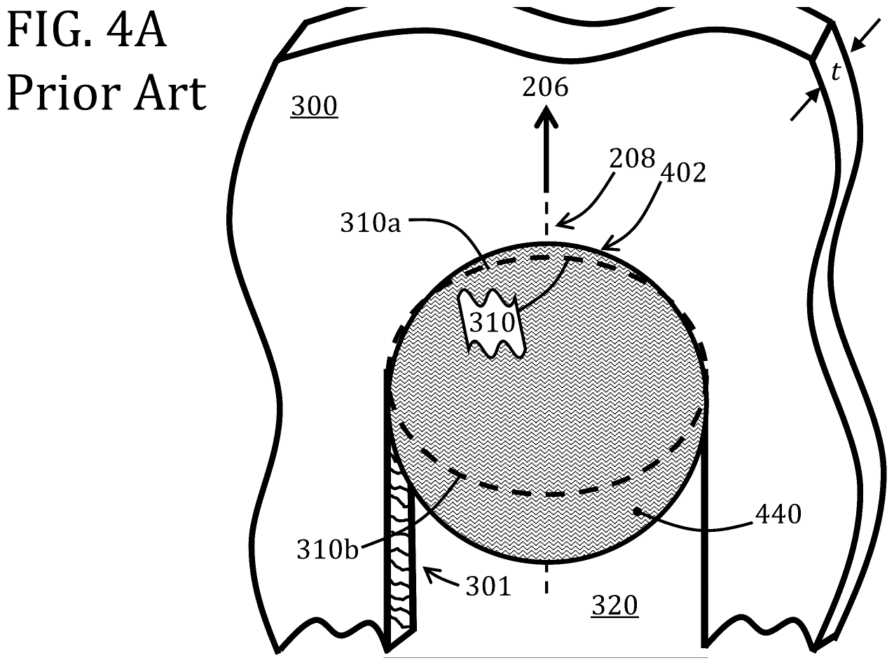

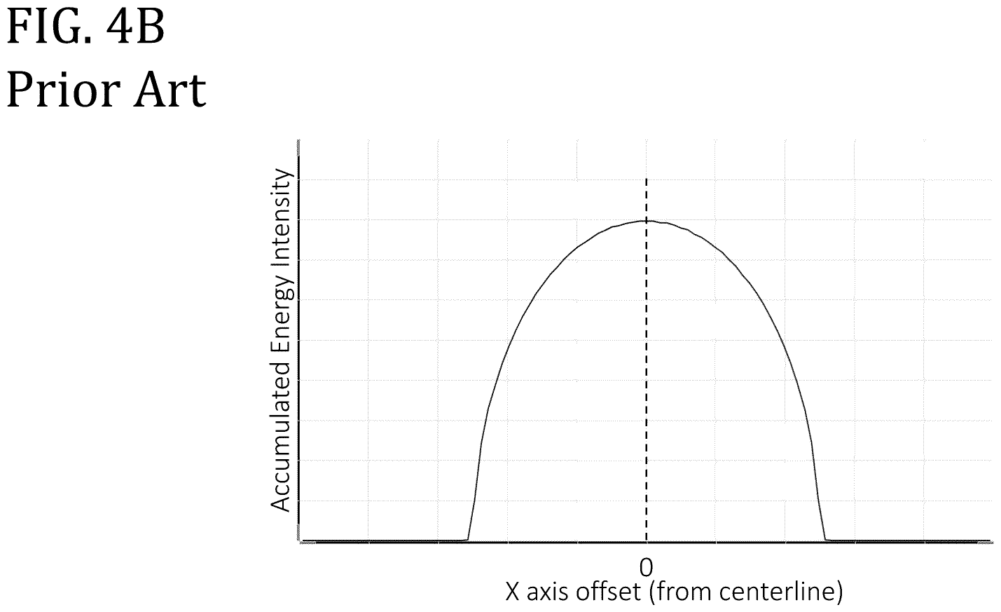

FIG. 4A shows another general configuration for processing a workpiece using a laser beam to cut a metal plate. FIG. 4A shows an example similar to that shown in FIG. 3A (with like reference numerals referring to similar features) except the beam spot profile 402 is homogeneous. Similar to FIG. 3A, the trailing edge 310b of the molten region 310 may not extend to the edge of the laser beam spot 402 such that energy 440 of the laser beam spot 402 may extend over the trailing edge 310b of the molten region 310, much like portions 220b of the projected laser beam 220a in FIG. 2. As such, the energy 440 of the laser beam spot 402 is also wasted. Moreover, sidewall portions 401 of the workpiece 400 are formed having a relatively increased number or intensity (as compared to embodiments described herein) ridges R extending through a thickness t of the workpiece 400. This may be due to increased concentration of energy in the center than at the kerf edges, resulting in less available heat at the edges or sidewall portions 401 and more cooling/groove formation.

FIG. 4B illustrates the accumulated energy intensity distribution profile of the laser beam spot 402 (in FIG. 4A). In FIG. 4A, laser beam spot 402 has a relatively uniform disk-like shape that is projected onto a surface of workpiece 400, such a uniform profile is often referred to as a “top-hat” because it transitions swiftly from little or no intensity to a high intensity in the center and then low again. The resulting accumulated energy intensity distribution profile has a deposited energy primarily still located along the centerline of the kerf (0 on the horizontal axis). Multimode fibers/lasers typically would result in a more homogeneous intensity distribution profile such as the embodiments of FIGS. 4A-4B, while single mode fibers/lasers would typically result in the more Gaussian-like distribution of FIGS. 3A-3B.

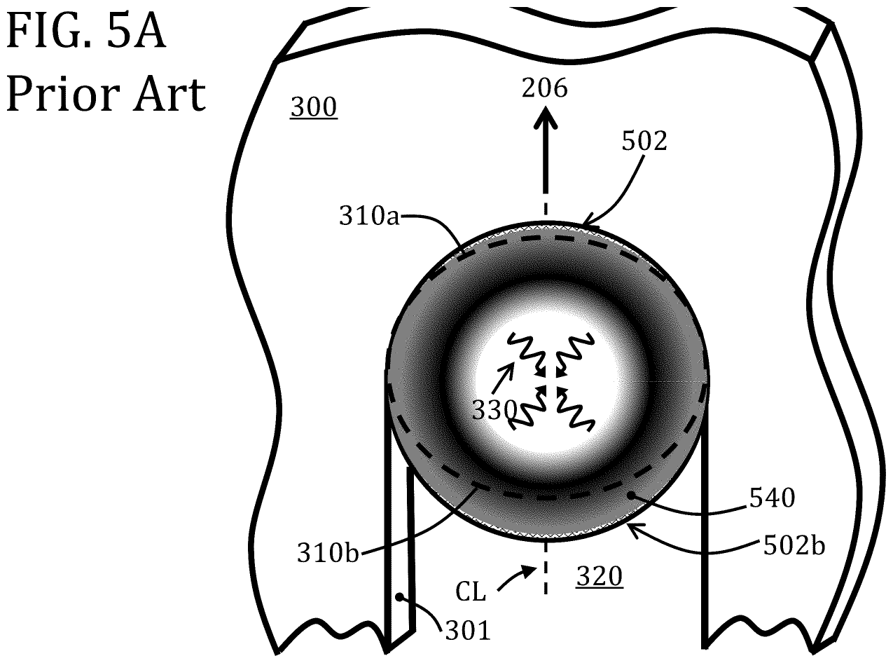

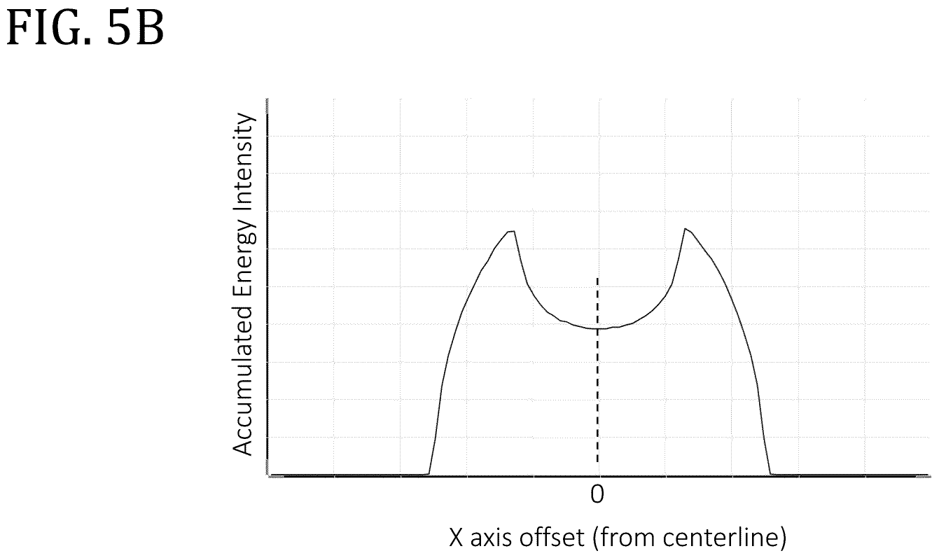

FIG. 5A shows another general configuration for processing a workpiece using a laser beam to cut a metal plate. FIG. 5A shows an example similar to that shown in FIGS. 3A and 4A (with like reference numerals referring to similar features) except the beam spot profile 502 is ring shaped with an area of decreased laser output in its center. Its associated accumulated energy intensity distribution profile is shown in FIG. 5B. Such a configuration requires a minimum kerf size (width) to sufficiently discharge (blow out) the molten region 310. And the configuration of FIG. 5A may not have sufficient absorption and heat transfer 330 to be effective for aluminum or stainless-steel workpieces and may still result in energy 540 being lost where the trailing edge 502b of the beam spot profile 502 extends beyond the molten region 310.

In FIGS. 3A, 4A, and 5A, energies 340, 440, and 540, the described beam spots can be used unidirectionally. However, such configurations can result in excess energy at the leading edge of the beam spot and the unused portions of the laser beam spots 302, 402, 502 along trailing edges 302b, 402b, and 502b are lost during the melting reaction with the workpieces 300. Accordingly, use of the laser beam spots 302, 402, 502 results in an inefficient use of laser power and additional heat losses, which contribute to an inefficient cutting process. Additionally, heat losses laterally into the workpieces 300 contribute to an inefficient cutting process. As a result, sidewalls 301 of the workpieces 300 along the kerfs 320 lack uniform surface texture through a thickness t of the workpiece 300, as well as a perpendicularity of the kerfs 320 with respect to the top/bottom surfaces of the workpieces 300. Likewise, the round foci/beam profiles of the prior art result in less-than-ideal relative energy input at the lateral edge of the kerf, and the heat conduction of the workpiece reduces the energy available at the edge even further still. Such disadvantages lead to poor surface quality throughout the cut.

Accordingly, solutions described herein provide laser cutting devices with improved cutting process efficiency, by which energy density of a laser beam spot produces improved surface uniformity along kerf sidewalls and increased kerf perpendicularity with respect to the top/bottom surfaces of a workpiece, and/or further reduces dross and burrs on the underside of the workpiece (opposite the incident laser beam), which ultimately reduces production costs.

Before explaining embodiments in further detail, it should be understood that the concepts set forth herein are not limited in their application to the construction details or component arrangements set forth in the following description or illustrated in the drawings. It should also be understood that the phraseology and terminology employed herein are merely for descriptive purposes and should not be considered limiting.

It should further be understood that any one of the described features may be used separately or in combination with other features. Other embodiments of structures, devices, systems, methods, features, and advantages described herein will be or become apparent to one with skill in the art upon examining the drawings and the detailed description herein. It's intended that all such additional structures, devices, systems, methods, features, and advantages be protected by the accompanying claims.

This disclosure describes using a laser device, system, and method that provides for an intensity distribution of a laser beam spot having improved efficiencies for workpiece processing. In particular, the laser devices, systems, and methods provide for improved intensity distributions of a laser beam spot that increases cutting speeds of a workpiece, creates less dross (molten material), reduces sidewall roughness, improves perpendicularity, and/or reduces gas consumption per length of material(s) removed from the workpiece.

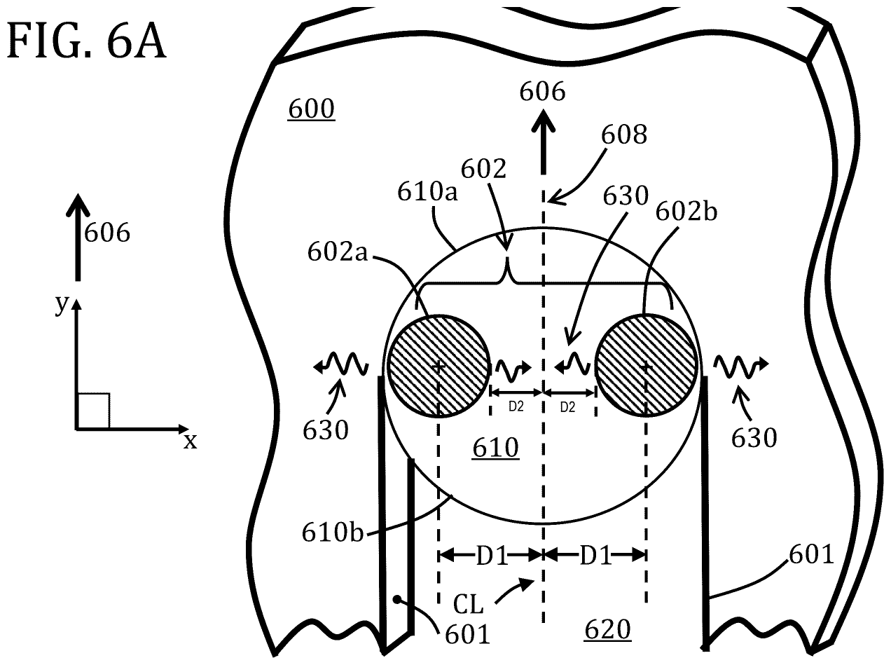

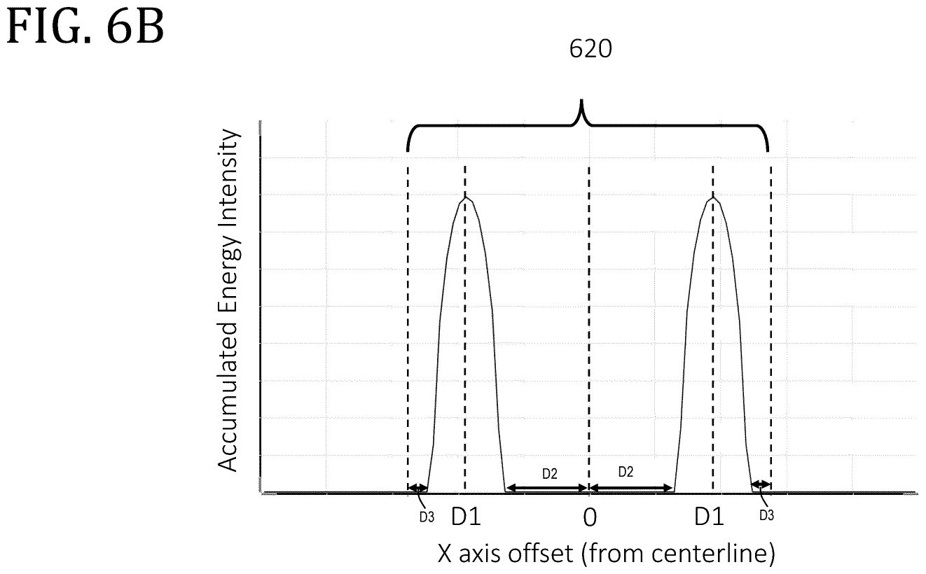

FIG. 6A is a plan view of an exemplary laser beam spot pattern. In FIG. 6A, a workpiece 600 is processed using a laser beam spot pattern 602 that progresses along a cutting path 606 to form a kerf 620 with a centerline (CL) 608. The cutting path 606 defines the y-axis and a perpendicular x-axis, which is parallel to the surface of the workpiece 600. Although not particularly shown, a cutting head, such as cutting head 5 (in FIG. 1), produces and/or promulgates the laser beam spot pattern 602 along with appropriate cutting gases. In some implementations, the cutting head may include laser devices and optics that produce a single laser beam or multiple laser beams. For example, the cutting head 5 may include a single laser device and optics that produce or promulgate the laser beam spot pattern 602, or the cutting head may include multiple laser devices and optics that produces the laser beam spot pattern 602. Additionally, the optics may provide for different laser beam spot patterns that include substantially the same or different laser beam spot geometries. For example, optics within the cutting head 5, or further upstream the optical chain, may produce laser beam spot patterns having one or more of circular-shaped laser beam spots and elongated-shaped laser beam spots, including laser beam spots having circular, oval, and linear shapes. Furthermore, the individual geometries generated can have different symmetries or asymmetries to each other, in shape, intensity distribution, and/or relative position.

As the laser beam spot pattern 602 is moved along cutting path 606, energy is absorbed by the workpiece 600 and the workpiece 600 is heated. Accordingly, portions of the workpiece 600 are melted to form melted region 610, which may also be referred to a molten puddle, and removed or blown out by supplied cutting gasses. The cutting head 5 and laser beam spot pattern 602 is typically advanced in concert with this action such that the melted region is continuously formed and removed. This molten region 610 is shown having a leading edge 610a and a trailing edge 610b. While FIG. 6A is a schematic representation, the relative positions of the leading edge 610a and training edge 610b to the laser beam spot pattern may differ. In one example, the beam spot pattern 602 (first and second beam spots 602a, 602b) will be closer to the leading edge 610a than the trailing edge 610b. As the molten region 610 is removed, e.g., by gas flow, a kerf 620 in the workpiece 600 is formed.

Additionally, as the laser beam spot pattern 602 moves along the cutting path 606, energy of the laser beam spot pattern 602, in the form of heat 630, is transferred to the workpiece. As discussed below, the laser beam spot 602 is arranged to account for and more efficiently use the heat transfer 630 resulting in a more even molten region 610 and less cooling/melting cycles at the edges of the kerf, which contributes to more even and smooth sidewall portions 601 and a greater absorption of the laser light.

As shown, the beam spot 602 includes a first beam spot 602a and a second beam spot 602b separated from first beam spot 602a. Beam spots 602a, 602b, represent the narrowest part of the laser beam incident onto the workpiece 600. For illustration purposes, the narrowest part of the laser beam is within the thickness of the workpiece 600. However, depending on the cutting process (e.g. depending on the material), the narrowest part of the beam spots 602a, 602b can also be above or below the workpiece 600. Each of first beam spot 602a and second beam spot 602b are circular and are centered a distance D1 from the centerline CL and have a distance D2 (in the x-axis) from their respective inner edges to the centerline CL of zero or greater. The first and second beam spots 602a, 602b, can have similar or the same diameters. In one example the first and second beam spots 602a, 602b have different diameters, which may be advantageous for example if the thickness of the workpiece is not uniform or if the cutting path 606 is curved. For example, the beam spot closer to the effective center of a curved cutting path may have a smaller diameter such that additional energy may be deposited for the longer cutting path toward the circumference. The centers of the first and second beam spots 602a, 602b may be on a line oriented with or perpendicular to the cutting path (FIG. 6A shows the line between their centers to be perpendicular to the cutting path 606). FIG. 6A shows the orientation perpendicular to the feed direction. In one example the diameters of each of beam spots 602a, 602b are less than 1000 microns. In another example the diameters of each of beam spots 602a, 602b are less than 300 microns, less than 20 microns, or less than 100 microns. In one example using a solid-state/fiber laser having a wavelength of about 1 μm, the diameters of each of beam spots 602a, 602b are each greater than 14 microns when using a solid-state or fiber laser. Each of first laser beam spot 602a and second laser beam spot 602b may have a non-zero distance D3 (in the x-axis) (FIG. 6B) between their outer edges and the sidewall portions 601. Each of D1, D2, and D3 may be pre-set or vary in view of the laser beam spot diameter and/or material(s) of the workpiece 600 and/or feed rate in the cutting direction and/or change of cutting direction. For example, in FIG. 6A, a distance between center regions of the first and second beam spots 602a and 602b may be approximately 50-100 μm, with an approximate equal spacing distance D1 from the center regions of the first and second laser beam spots 602a and 602b to a centerline CL of the cutting path 606 being about 25-50 μm. In some implementations, diameters of the first and second laser spots 602a and 602b may be substantially the same. For example, diameters of the first and second laser beam spots 602a and 602b may be approximately 35-100 μm.

In some implementations, individual diameters of the first and second laser beam spots 602a and 602b may be varied, either individually or in a grouping. For example, diameters of the first and second laser beam spots 602a and 602b may each be different or substantially the same from each other.

Although each of first beam spot 602a and second beam spot 602b are shown being symmetric across the centerline CL, which provides for uniformity across the centerline, other variations are allowable. By separately configuring first beam spot 602a and second beam spot 602b, additional control is provided for tuning the beam spot pattern 602 for the intended molten region 610. As shown, beam spot pattern 602 is entirely contained within the confines of the molten region 610, which results in a more efficient use of laser power. In other examples of use, to the extent that any of the beam spot 602 extends over the edge of molten region 610, that extension (and energy loss) is reduced as compared to the prior art. As such, the energy of the laser beam spot pattern 602 contributes more evenly to the melting reaction with the workpiece 600 in order to create kerf 620 in the workpiece 600. Accordingly, sidewalls 601 of the workpiece 600 have substantially more uniform surfaces through a thickness of the workpiece 600, and the sidewalls 601 are substantially more perpendicular to top/bottom surfaces of the workpiece 600.

In some implementations, an energy intensity distribution of the laser beam spot pattern 602 may be varied in different directions and independently. For example, energy intensity distribution of the laser beam spot pattern 602 may be independently varied along a direction of the cutting path 606 or independently varied along a direction substantially perpendicular to a direction of the cutting path 606.

In some implementations, the laser beam spot pattern 602 can be either concentric or eccentric to a cutting nozzle. For example, using the cutting head 5 and cutting nozzle 10 (in FIG. 1), the laser beam spot pattern 602 can be either concentric or eccentric to the cutting nozzle 10, such as a centerline of the cutting nozzle 10.

FIG. 6B shows the accumulated energy intensity distribution profile of the beam spot pattern 602 of FIG. 6A and shows a higher accumulated energy intensity distribution closer to the edges of kerf 620 than the centerline CL. This configuration influences the cooling rate on the sides of the kerf, i.e., allows greater flexibility in how much heat is applied near the kerf edges. By applying additional accumulated energy intensity at the edges, the melts on the side of the molten region 610 should remain liquid for longer and not solidify too early, thus reducing striations and assisting in maintaining a sufficiently stable molten pool such that the total relative amount of the emitted laser energy absorbed by the workpiece is increased.

In some implementations, individual diameters of the first and second laser beam spots 602a and 602b may be varied, either individually or in a grouping. For example, diameters of the first and second laser beam spots 602a and 602b may each be different or substantially the same. In some implementations, diameters of the individual beam spots may be approximately 35-100 μm.

In some implementations, locations of the first and second laser beam spots 602a and 602b with respect to the cutting path 606 may be varied, either individually or in a grouping. Additional examples of such variations will be discussed below. For example, the first and second laser beam spots 602a and 602b may be asymmetrically disposed along the cutting path 606. The spots can also be arranged in a row in relation to the cutting direction, i.e., so that a line through the beam spots aligns with the centerline CL or is parallel to it. The distance and size of the spots could also be adjusted depending on the material and process.

In some implementations, a power density of the first and second laser beam spots 602a and 602b may be varied. For example, a power density of the first and second laser beam spots 602a and 602b may be substantially the same or different.

In some implementations, an energy intensity distribution of the first and second laser beam spots 602a and 602b may be varied. For example, the energy intensity distribution of the first laser beam spot 602a may be substantially the same or different from the second laser beam spot 602b. Further, each of beam spots 602a, 602b may each have varied intensity distributions. For example, each may have top-hat intensity profiles, for example if they have a diameter greater than about 100 μm or Gaussian-like, if they are smaller.

In some implementations, any of the diameters, locations, power density, and/or energy intensity distribution of the first and second laser beam spots 602a and 602b may be substantially the same or different, in combination or individually.

While FIG. 6A depicts that the molten region 610 as circular shape, such circular shape is merely representative of a projection of the molten region when viewed orthogonal to the workpiece. Further, the relative locations, sizes, movement speed, workpiece material thickness and energy densities, as well as other characteristics, of the first and second laser beam spots 602a and 602b may result in the molten region 610 having a geometry other than the circular shape. For example, the leading edge 610a and/or trailing edge 610b of the molten region 610 may be moved forward or backward (relative to the direction of the cutting path 606) or having more or less of a parabolic or elliptical shape depending on the above variables.

Since heat 630 produced by the first and second laser beam spots 602a and 602b is transferred and retained more evenly within the molten region 610, and because more of the relative emitted laser beam interacts with the workpiece (e.g. higher absorption/utilization of the radiation) a time to melt the material(s) of the workpiece 600 in the molten region 610 to produce kerf 620 may be reduced, and cutting speed of the workpiece 600 (unit of length over time) can be increased. Further, laser beam spot pattern 602 may result in a more even heat distribution such that the overlap of laser beam spot pattern 602 beyond the trailing edge 610b of molten region 610 is reduced or eliminated, which ultimately leads to a more efficient use of laser power. Further, because of the retention of energy and heat, the accumulated energy intensity distribution of the laser beam spot pattern 602 results in a higher, prolonged processing temperatures at interfaces of the workpiece 600 with the laser beam spot pattern 602, allowing more control over the melting and cooling of the edges. Moreover, since the time to melt the material(s) of the workpiece 600 within the molten region 610 is reduced, gas consumption per unit length of material(s) removed from the workpiece 600 can also be reduced.

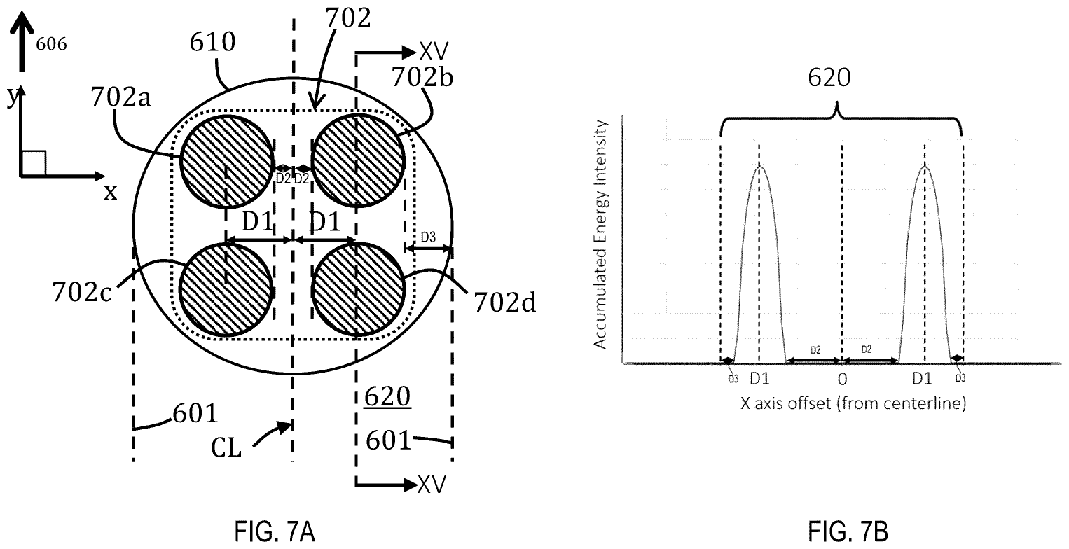

FIG. 7A is a plan view of an exemplary laser beam spot pattern. FIG. 7A shows a laser beam spot pattern 702 similar to that of FIG. 6A (where like reference numerals refer to similar features) and thus the advantages and features discussed above with respect to FIGS. 6A-6B are equally applicable to that of FIG. 7A and FIG. 7B. Although some features described with referenced to FIG. 6A have been omitted for clarity. FIG. 7B shows a laser beam spot pattern 702 with a plurality of laser beam spots, namely first beam spot 702a, second beam spot 702b, third beam spot 702c, and fourth beam spot 702d. Whereas laser beam spot 602 provided for splitting the beam spot 702 in the horizonal axis x, the beam spot 702 provides for splitting the beam spot 702 in the horizonal axis x and the vertical (cutting direction) axis y to provide additional control over the location of energy absorption within the molten region 610, which may provide even more of the benefits described above with respect to FIGS. 6A-6B. Further, the widened and/or elongated beam spot pattern can provide for a longer cutting front with a flatter angle (discussed further below), a wider kerf to provide for better removal of the melt, and a more vertical sidewall with less roughness by controlling/minimizing cooling/re-solidification of the molten region at the sidewalls 601.

FIG. 7B shows the accumulated energy intensity distribution profile of the beam spot pattern 702 of FIG. 7A. The profile of FIG. 7B is the same as that of FIG. 6B, although the height (vertical axis), and location and width of the peaks may be different depending on the size and location of individual beam spots 702a, 702b, 702c, and 702d.

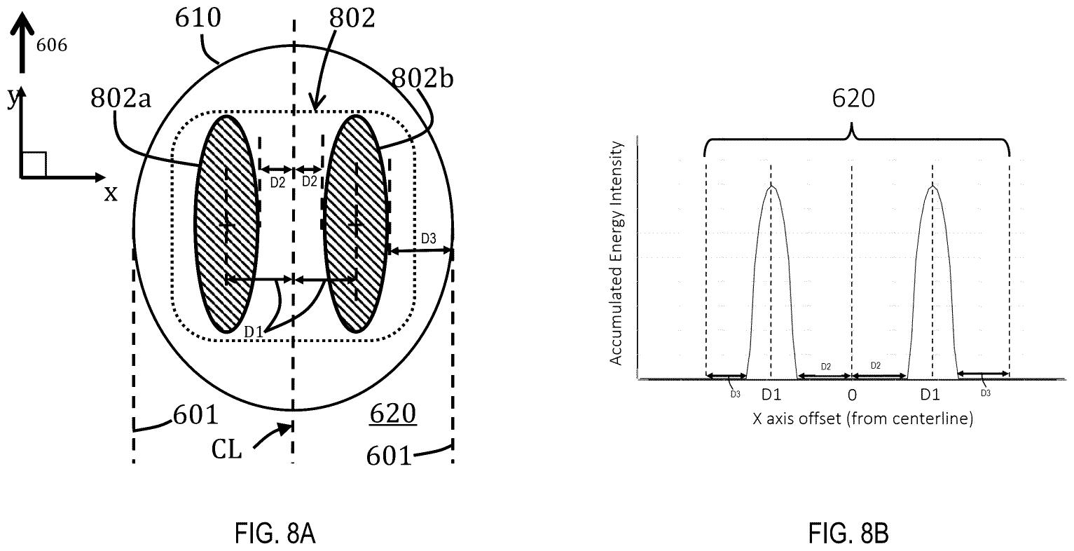

FIG. 8A is a plan view of an exemplary laser beam spot pattern. FIG. 8A shows a laser beam spot pattern 802 similar to those of FIGS. 6A and 7A (where like reference numerals refer to similar features) and thus the advantages and features discussed above with respect to FIGS. 6A-7B are equally applicable to that of FIG. 8A and FIG. 8B. Although some features described with referenced to FIGS. 6A and 7A have been omitted for clarity. FIG. 8A shows a laser beam spot pattern 802 with a plurality of laser beam spots, namely first beam spot 802a, and second beam spot 802b. As discussed above, the individual beam spots may vary in shape, width, and intensity. As shown in FIG. 8A, the first and second beam spots have an elongated shape in the y axis, which can provide additional control over the location of energy absorption within the molten region 610. While the example shown shows each of the first and second beam spots having an ovular shape with their major axis being parallel to the y-axis, the beam spots may also have other elongated shapes as well, for example rectangular shapes. In one example the longest dimension of the beam spots may be approximately 100 μm or more, for example up to about a few millimeters. Further, as shown in FIG. 8A, the molten region 610 may also vary in shape depending on the beam spot pattern and is shown here as oval shaped projection with the major axis being aligned with the centerline CL. FIG. 8B shows the accumulated energy intensity distribution profile of the beam spot pattern 802 of FIG. 8A. The general profile of FIG. 8B is the same as that of FIGS. 6B and 7B, although the height (vertical axis), and location and width of the peaks may be different depending on the size, location, intensity and intensity distribution of individual beam spots 802a, 802b.

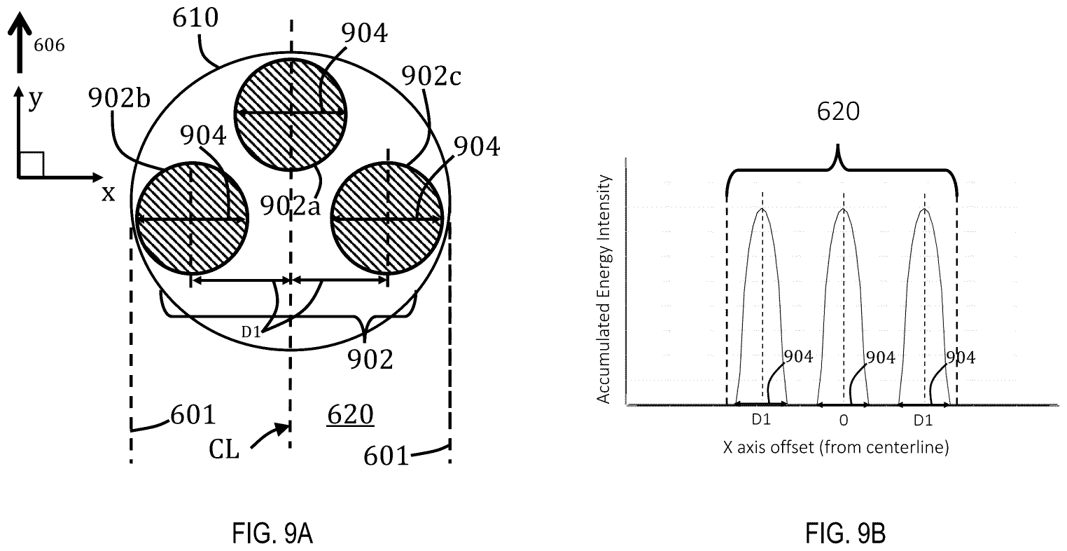

FIG. 9A is a plan view of an exemplary laser beam spot pattern. FIG. 9A shows a laser beam spot pattern 902 similar to those of FIGS. 6A-8A (where like reference numerals refer to similar features) and thus the advantages and features discussed above with respect to FIGS. 6A-8B are equally applicable to that of FIG. 9A and FIG. 9B. Although some features described with referenced to FIGS. 6A-8B been omitted for clarity. FIG. 9A shows a laser beam spot pattern 902 with a plurality of laser beam spots, namely first beam spot 902a, second beam spot 902b, and third beam spot 902c, each having a diameter 904 that is shown being equal to each other, although, if desired to vary the energy absorption, the diameters 904 may vary. As discussed above, the individual beam spots may vary in shape, width, and intensity. As shown in FIG. 9A, the centers of each of the first, second, and third beam spots 902a, 902b, and 902c, form a triangular shape, in which the center of that triangle is forward of the midpoint of the molten region 610 in the y axis. Further, while the beam spot pattern 902 is symmetric about the centerline (CL), it is not symmetric about a line parallel to the x axis that traverses the beam spot pattern. Further, as shown in FIG. 9A, the molten region 610 may also vary in shape depending on the beam spot pattern and is shown here as oval shape with its major axis parallel to the x axis, although with different arrangements of the individual beam spots 902a, 902b, and 902c, and or different processing parameters, the major axis may also be parallel with the y axis, or in between. Such a configuration may be particularly useful for thicker materials, where a wide kerf is required to blow out the melt and, accordingly, where more material is melted, which in turn requires more energy.

FIG. 9B shows the accumulated energy intensity distribution profile of an example beam spot pattern 902 like that of FIG. 9A assuming that each beam spot has the same power density. While FIG. 9A shows overlap in the x dimension of the three beam spots, FIG. 9B shows a variation in which the diameters 904 and distances D1 are such that the individual accumulated energy intensity distribution profiles for each of the first, second, and third beam spots 902a, 902b, and 902c don't overlap. However, in another example the diameters 904 and distances D1 are such that the individual accumulated energy intensity distribution profiles for each of the first, second, and third beam spots 902a, 902b, and 902c do overlap. As noted above, the height (vertical axis), and location and width of the peaks may be different depending on the size, location, and intensity of individual beam spots 902a, 902b, and 902c.

Further, while the diameters of each of the first, second, and third beam spots 902a, 902b, and 902c are shown to be equal, in some implementations, individual diameters of the first to third laser beam spots 902a-c may be varied, either individually or in groupings. For example, diameters of the first to third laser beam spots 902a-c may each be different. In another example, the first laser beam spot 902a may have a first diameter, and the second and third laser beam spots 902b and 902c may each have a second diameter different from the first diameter. Alternatively, the first laser beam spot 902a and one of the second and third laser beam spots 902b and 902c may each have a first diameter, and the other of the second and third laser beam spots 902b and 902c may have a second diameter different from the first diameter.

In some implementations, an energy intensity distribution of the first to third beam spots 902a-c may be varied. For example, the energy intensity distribution of any of the first to third beam spots 902a-c may be substantially the same or different. In some implementations, an energy intensity distribution of the first to third laser beam spots 902a-c may be varied in different directions and independently. For example, energy intensity distribution of the first to third beam spots 902a-c may be independently varied along a direction of the cutting path 606 or independently varied along a direction substantially perpendicular to a direction of the cutting path 606.

In some implementations, any of the first to third beam spots 902a-c can be either concentric or eccentric to a cutting nozzle. For example, using the cutting head 5 and cutting nozzle 10 (in FIG. 1), any of the first to third beam spots 902a-c can be either concentric or eccentric to the cutting nozzle 10, such as a centerline of the cutting nozzle 10.

These variations are equally applicable to the other individual beam spots disclosed throughout this application.

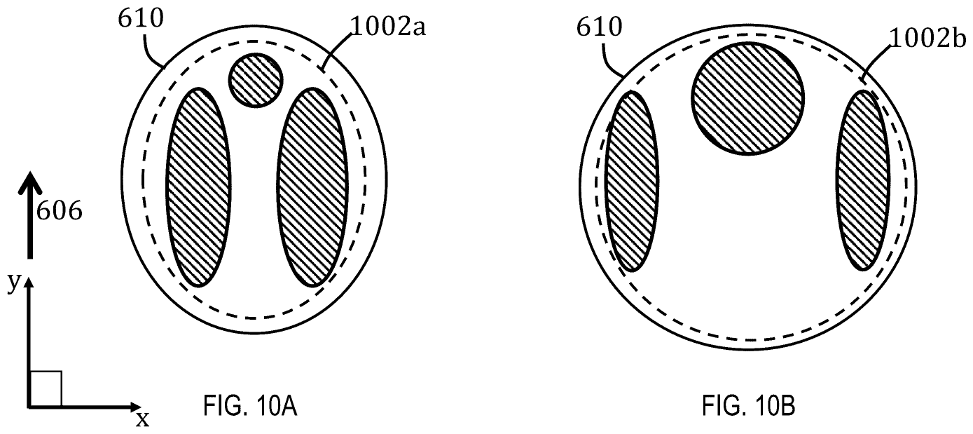

FIGS. 10A and 10B show alternative beam spot patterns 1002a and 1002b each having three individual non-overlapping beam spots and respective molten regions 610 having different shapes. The outer beam spots of beam spot pattern 1002b are further from the centerline and shorter in the y axis resulting in a wider molten region 610 as compared to the molten region of FIG. 10A. Further, as discussed above, the individual beam spots can have varying power densities. For example, the more forward beam spot can have a higher or lower power density than the two outer beam spots.

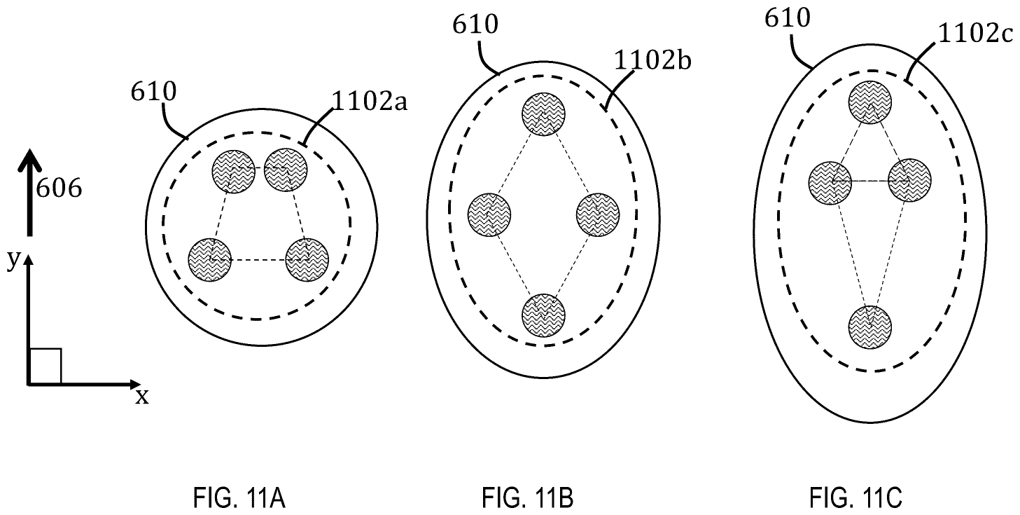

FIGS. 11A-11C show alternative beam spot patterns 1102a, 1102b, and 1102c each having four individual non-overlapping beam spots and respective molten regions 610 having different shapes. Beam spot pattern 1102a includes first, second, third, and fourth beam spots forming a trapezoid with their respective centers. Beam spot pattern 1102b includes first, second, third, and fourth beam spots forming a rhombus with their respective centers. Beam spot pattern 1102c includes first, second, third, and fourth beam spots forming a “kite” shape with their respective centers.

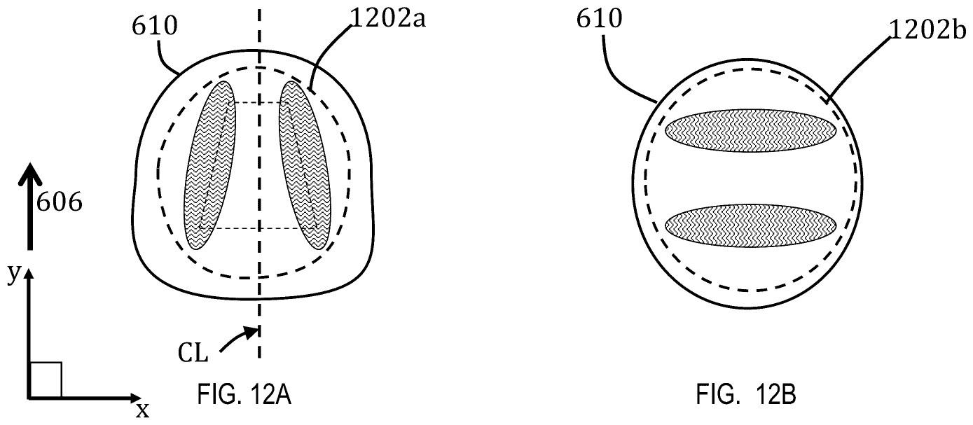

FIGS. 12A-12B show alternative beam spot patterns 1202a and 1202b each having two individual non-overlapping beam spots and respective molten regions 610 having different shapes. Beam spot pattern 1202a includes first and second elongated (ovular) spots with their longitudinal (or major) axis tilted in towards the centerline CL. Beam spot pattern 1102b includes first and second elongated (ovular) beam spots with their longitudinal (or major) axis aligned with the x axis, i.e., perpendicular to the cutting direction.

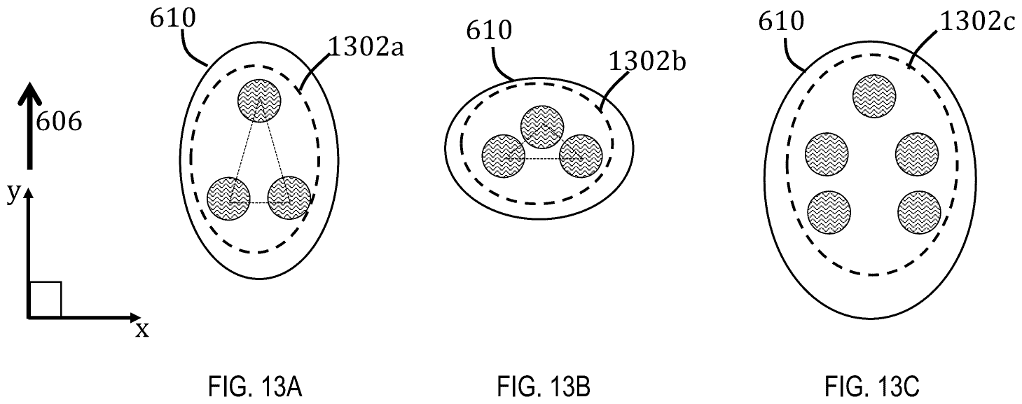

FIGS. 13A-13C show alternative beam spot patterns 1302a, 1302b, and 1302c each having individual non-overlapping beam spots and respective molten regions 610 having different shapes. Beam spot pattern 1102a includes first, second, and third beam spots forming an elongated triangle with their respective centers. Beam spot pattern 1302b includes first, second, and third beam spots forming a short triangle with their respective centers. Beam spot pattern 1302c includes first, second, third, fourth, and fifth beam spots.

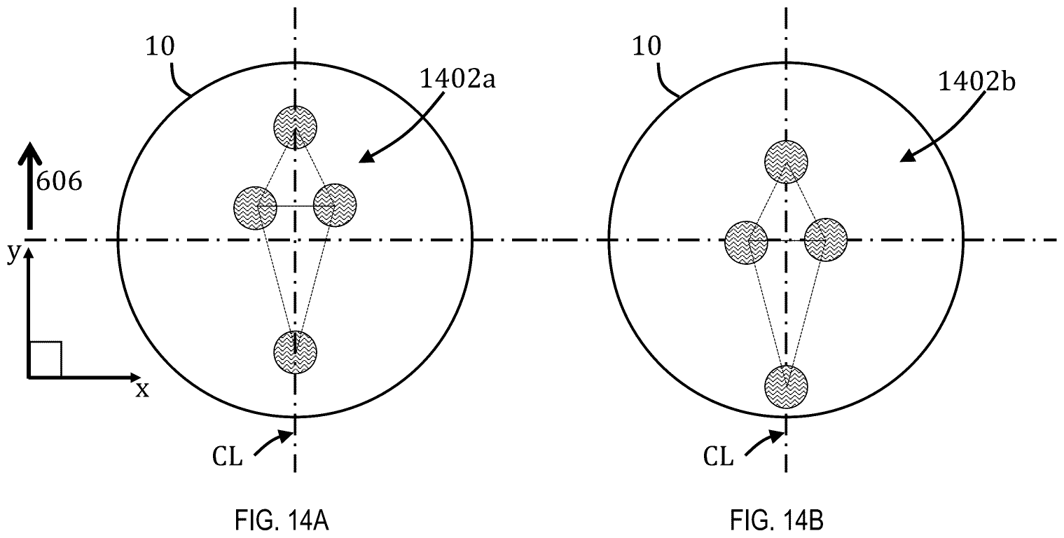

FIGS. 14A and 14B show example beam spot pattens with respect to the inner or smallest diameter of the cutting nozzle 10. Because the cutting gas profile is not impacted by the beam spot pattern, disclosed embodiments may off-center the beam spot profile in one or both of the x and y axis with respect to the nozzle center. For example, beam spot pattern of FIG. 14A has the beam spot pattern more forward (as compared to FIG. 14B) in the direction of cutting, which can provide more time for the gas to blow out molten material. Likewise, if less time is not desired, i.e., to control the size of the molted region, the beam spot pattern can be moved more toward the rear as in FIG. 14B.

Although the various beam spot patterns of FIGS. 6A-14B have been discussed with respect to non-overlapping beam spots to form the pattern, in each example, the beam spots may also overlap each other as the size of each beam spot increases or the distance between each spot decreases. In such cases the location of each individual beam refers to their respective centers or centroid. Further, while the descriptions and examples of FIGS. 6A-14 have been described with respect to a static snapshot in time, the beams spots need not be static and during processing/cutting of a material, the beam spot patterns may change (such as the respective diameters, power distributions, spacings, or relative positions, etc.) dynamically during the process depending, among other factors on process speed, direction, rotation, or based on other dynamic process input, e.g., the size and shape of the molten region, or feedback based on the roughness of the kerf sidewalls.

The disclosed example embodiments with variations of beam spot patterns provide for a more efficient and controllable absorption of laser light into a material workpiece. Metal, which is commonly cut with disclosed lasers usually reflect laser light better than it absorbs it. The absorption of laser radiation depends on many parameters, e.g. angle of incidence, temperature, surface properties, and material.

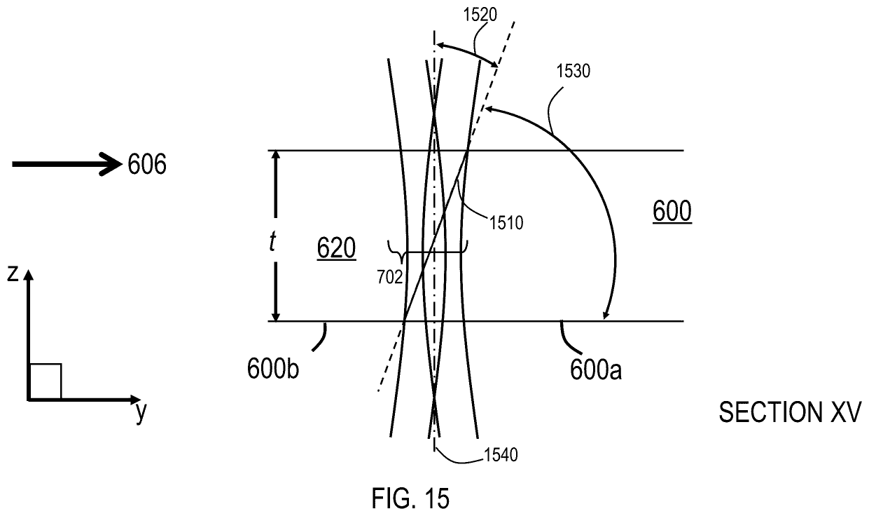

FIG. 15 shows an example cross section of a laser beam spot pattern 702 cutting a workpiece 600. The cross section is taken, for example along cross section XV of FIG. 7A where the direction of travel 606 is in the same plane of the paper. The beam pattern 702 of FIG. 7A is shown at the focal point of the laser, which is about at the middle of the thickness t of the workpiece 600, although the beam profile may be focused toward the top or bottom of the workpiece (along the z axis) or even outside of the material depending on the material type and desired configuration. As the workpiece melts the molten region, it forms a cutting front 1510 having a cutting front angle 1520 off of vertical 1540. Because the laser beam patterns disclosed herein are incident into the cutting front 1510, the cutting front angle 1520 also defines angle of incidence 1530, which is 90° minus the cutting front angle. It should be noted that although the cutting front 1510 is shown schematically as being linear, the cutting front may have different shapes including parabolic or being “s” patterned. However, the cutting front angle would nevertheless be the linear approximation of such patterns.

For each metal there is an optimum angle of incidence at which the absorption is greatest (which is based on Brewster's angle). As an example for iron, aluminum, and copper, this angle of incidence lies in a range of approximately 78 to 85°. Accordingly, disclosed beam spot patterns provide for influencing/modifying the cutting front length (determined by the cutting front angle 1520 and the thickness t of the workpiece 600) by arranging the beam spot patterns (in close connection with the cutting speed and/or change in cutting direction) to keep the cutting front angle 1520 (and thus the angle of incidence 1530) to an ideal level for the given material. This is accomplished while still maintaining sufficient energy at the kerf edges to improve cut quality by ensuring that the melt remains liquid from top to bottom until it is expelled from the kerf to reduce burrs and minimize solidification mechanisms, which reduces roughness of the cutting edges. For example, as the length of the ovular shape of the molten beam spots increases and the ability to melt the entire cutting front is maintained (due to power density or accumulated energy intensity distribution profile), the angle of incidence can be adjusted towards a more desirable 75 to 85°. Further, the length and spacing of the ellipses can be adjusted depending on material, thickness, and feed rate. For example, at higher cutting speeds, the cutting front angle typically becomes flatter, so it can be useful to push the spots closer together (in the y-axis direction). In one example, the spots may overlap no more than ⅔ of their area at the focal point. In another example, as the material gets thicker, to obtain the desired cutting front angle, it may be beneficial to move the spots further apart (in the y-axis direction), with the maximum distance depending on the angle, material thickness, beam diameter, speed of the beam, and other process parameters.

As disclosed herein, the disclosed beam spot patterns as well as the beam focus points can be determined by optics, other beam shaping elements, and/or waveguides. For example, a round spot is produced by radially symmetric spherical and aspherical optical elements or parabolic off-axis mirrors. A twin spot can be produced by e.g. a wedge-shaped prism element in combination with the elements above. An elongated spot, or line spot can be produced by cylindrical elements or by refractive or diffractive beam shaping elements. The ring can be produced by an axicon element, or a ring-shaped fiber source is used. Other ways to produce the described characteristics of the spot patterns, are known to an artist skilled in the art. Any multiple spot arrangement can also be produced by having multiple sources or one source coupled to a fiber cable with multiple cores. The cores of the fiber cable may also have non-circular cross-sections (e.g., ovular, rectangular, etc . . . ). In addition, freeform beam shaping elements may also be used to create the disclosed beam shape and pattern. In principle, all elements can be transmissive or reflective or a combination thereof. The elements may also be translated in any axis and/or rotated with respect to each other, to adapt the spot pattern to the present cutting process. Further, the laser sources themselves could be single mode or multi-mode.

A method for cutting a workpiece may comprise implementing any of the embodiments discussed above. In some implementations, cutting a workpiece may include using a cutting head in order to produce a shaped laser beam pattern. For example, in FIGS. 5-15, a workpiece may be processed using any of the laser beam spot patterns described above, in which a laser beam spot pattern is produced to cut material(s) of the workpiece.

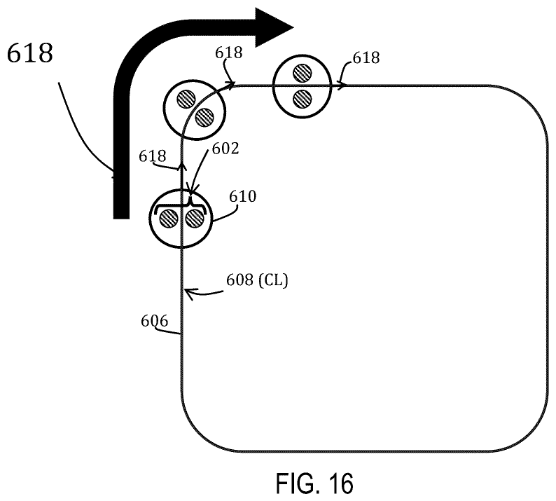

In FIGS. 6-15, workpiece 600 can be processed by cutting/processing material(s) using laser beam spot pattern 602/702/802/902/1002a-b/1102a-c/1202a-b/1302a-c/1402a-b produced or promulgated by a cutting head 5 (in FIG. 1). The cutting head may also be used to align the spot pattern with the current cutting direction, by e.g. rotating the beam-shaping elements or the cutting head accordingly. For example, FIG. 16 shows an example of beam spot pattern 602 discussed above with reference to FIGS. 6A and 6B, as it progresses through a non-linear cutting path 606. In the example shown in FIG. 16, the beam spot pattern is rotated to maintain its relative orientation with respect to the centerline CL 608 of the cutting path changing its cutting direction 618 to follow the cutting path 606. Although FIG. 16 shows an example with respect to beam spot pattern 602, it is equally applicable to any other beam pattern that is direction dependent, i.e., beam spot patterns that are not radially and centerline symmetric. Radial and centerline symmetric beam shape patterns include circle and ring shapes shown in FIGS. 3A, 4A, and 5A, while direction dependent beam shape patterns include the double spot (602, 802, 1202a, 1202b), square/quad/pent (702, 1102a, 1302c), triangle (902, 1002a, 1002b, 1302a, 1302b), and diamond/kite (1102b, 1102c, 1402a, 1402b). Accordingly, the laser energy may be deposited in an optical location with respect to the cutting path. Rotation of the beam spot patterns may be achieved, for example, by rotating the beam shaping element during the cutting process or other rotational means known to a person of ordinary skill given the contents of this disclosure. Optionally, data exchange with the higher-level control system may also be executed as well as feedback sensors, i.e., orientation sensors, angle sensors, step counters, encoders or the like, to detect the angle of rotation and provide for closed loop feedback control.

A system for processing a workpiece may comprise implementing any of the embodiments discussed above. In some implementations, cutting/processing a workpiece may include using a system including a cutting head in order to produce a shaped laser beam spot pattern. For example, in FIGS. 5-15, a system using a cutting head producing any of the laser beam spot patterns described above may be implemented to process a workpiece. Further, in another example, and as described above, the beam spot pattern could also be generated by the system, the integrated laser, or the integrated fiber, and not by the cutting head itself.

In FIGS. 6-15, a system using a cutting head 5 (in FIG. 1) configured to produce laser beam spot pattern 602/702/802/902/1002a-b/1102a-c/1202a-b/1302a-c/1402a-b can be used to process workpiece 600.

The method steps in any of the embodiments described herein are not restricted to being performed in any particular order. Also, structures mentioned in any of the method embodiments may utilize structures mentioned in any of the device embodiments. Such structures may be described in detail with respect to the device embodiments only but are applicable to any of the method embodiments.

Unless specific arrangements described herein are mutually exclusive with one another, the various implementations described herein can be combined in whole or in part to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for processing a workpiece, the system comprising:
a laser cutting head configured to produce a laser beam spot pattern comprising a plurality of laser beam spots,
wherein at least two laser beam spots of the plurality of laser beam spots being disposed within the laser beam spot pattern symmetrically from a centerline defined by a cutting path for processing the workpiece.

2. The system according to claim 1, wherein the at least two laser beam spots have one of a circular shape and an elongated shape, and
wherein the at least two laser beam spots have a center region spaced apart from the centerline of the cutting path by a distance.

3. The system according to claim 2, wherein the plurality of laser beam spots include an additional laser spot disposed within the laser beam spot pattern and disposed symmetrically along the centerline of the cutting path.

4. The system according to claim 1, wherein at least one of the laser beam spots has an energy intensity distribution profile comprising one of a Gaussian profile, a top-hat profile, and a ring profile.

5. The system according to claim 1, wherein each of the at least two laser beam spots include an oval-shape.

6. The system according to claim 1, wherein the at least two laser beam spots include at least three laser beam spots, in which the at least three laser beam spots are symmetrically disposed apart from the centerline of the cutting path.

7. A laser processing system, comprising:
a laser cutting head configured to process a workpiece; and
a process controller configured to control the laser cutting head to produce a laser beam spot pattern comprising at least two laser beam spots, each disposed within the laser beam spot pattern and symmetrically positioned away from a centerline of a cutting path of the workpiece.

8. The laser processing system according to claim 7, wherein the at least two laser beam spots have one of a circular shape, an oval shape, and an elongated shape.

9. The laser processing system according to claim 7, wherein the at least two laser beam spots have a center region spaced apart from a centerline of the cutting path by a distance.

10. The laser processing system according to claim 7, wherein the laser beam spot pattern includes an additional laser spot disposed within the laser beam spot pattern and disposed symmetrically along a centerline of the cutting path.

11. The laser processing system according to claim 7, wherein the laser beam spot pattern has an energy intensity distribution profile comprising one of a Gaussian profile and a flat-top profile and a ring profile.

12. The laser processing system according to claim 7, wherein each of the at least two laser beam spots include an oval-shape.

13. The laser processing system according to claim 7, wherein the at least two laser beam spots include a first pair of laser beam spots and a second pair of laser beam spots, each symmetrically disposed apart from a centerline of the cutting path.

14. The laser processing system according to claim 7, wherein the cutting path is non-linear and the process controller is configured to rotate the laser beam spot pattern to maintain an alignment with the cutting path.

15. A method of processing a workpiece, the method comprising:
emitting, by a laser cutting head, a laser beam spot pattern comprising at least two laser beam spots, each disposed within the laser beam spot pattern and symmetrically positioned away from a centerline of a processing path of the workpiece; and
removing portions of the workpiece using the laser beam spot pattern along the cutting path of the workpiece.

16. The method of claim 15, wherein the at least two laser beam spots have one of a circular shape and an oval shape.

17. The method according to claim 15, wherein the at least two laser beam spots have a center region spaced apart from a centerline of the cutting path by a distance.

18. The method according to claim 15, wherein the laser beam spot pattern includes an additional laser spot disposed within the laser beam spot pattern and disposed symmetrically along a centerline of the cutting path.

19. The method according to claim 15, wherein the laser beam spot pattern has an energy intensity distribution profile comprising one of a Gaussian profile and a flat-top profile and ring profile.

20. The method according to claim 15, wherein each of the at least two laser beam spots include an oval-shape.

21. The method according to claim 15, wherein the at least two laser beam spots include a first pair of laser beam spots and a second pair of laser beam spots, each symmetrically disposed apart from a centerline of the cutting path.

22. The method according to claim 15, wherein the processing path is non-linear and the method further comprises rotating the laser beam spot pattern to maintain an alignment with the processing path.
